(19) United States
(12) Patent Application Publication
(10) Pub. No.: US 2014/0129608 A1
(43) Pub. Date: May 8, 2014

(54) DISTRIBUTED PRODUCTION PIPELINE

(71) Applicant: NEXT EDUCATION, LLC, Emeryville, CA (US)

(72) Inventors: Bobby S. BECK, Oakland, CA (US); Lance C. BURTON, Kensington, CA (US); Kevin CURETON, San Francisco, CA (US)

(21) Appl. No.: 14/070,298

(22) Filed: Nov. 1, 2013

Related U.S. Application Data
(60) Provisional application No. 61/721,984, filed on Nov. 2, 2012.

(51) Int. Cl. H04L 29/08

(52) U.S. Cl. CPC H04L 29/08135
USPC 709/201

(57) ABSTRACT

Technology is disclosed for developing digital content in a distributed content production environment. The technology can receive a request from a client system to access media files associated with digital content, where the media files are to be used for performing a plurality of tasks. The request further includes an indication of a particular task to be performed by the client system. The technology can determine a subset of media files used for performing the particular task. The subset of media files is determined by utilizing the dependency between the particular task and one or more assets to be used for performing the particular task. The technology can gather and provide the determined subset of media files to the client system.

### CROSS-REFERENCES

This application claims priority to U.S. Provisional Application No. 61/721,984, filed Nov. 2, 2012, which is hereby incorporated by reference in its entirety.

### TECHNICAL FIELD

This invention generally relates to digital content development, and more specifically to a distributed development of digital content.

### BACKGROUND

The production of digital content, such as animated movies, games, commercials, cover photos, models and rigs, music, etc., is a highly complex process that requires significant resources, including time and money. Further, the number of processes involved in producing digital content at a high quality not only increases the amount of data that needs to be handled but also the complexity of interaction between each of the processes. To speed up the development of complex digital content while implementing the various production processes, the studios have groups of artists, which includes animators, visual effects engineers, etc., working in parallel on one or more production processes at any given time.

Further, the groups working in parallel utilize collaterals being developed by each other, requiring the continuous sharing of the various collaterals across different groups of artists at any given time. Currently, each group gathers the various collaterals being developed by it and sends the collaterals to the other groups that require them to develop their work product. Further, the collaterals being developed within a given group is constantly being shared within the group's artists to enable them to perform the tasks for which each one is responsible.

However, such a method of sharing collaterals is very inefficient and fraught with complications. For example, if one of the collaterals gathered and provided by an artist in a given group is the incorrect version of the collateral, the entire work product of the group could suffer substantial quality issues when the incorrect collateral is used by other members of the group to perform their task. Further, such a nightmare scenario could propagate across different groups, compromising the entire final product. For example, lighting development depends on animation collaterals, texture collaterals, etc., where a quality issue with the animation collaterals affects any final lighting collaterals developed based on the animation collaterals. It should be noted that the terms collaterals and assets are used interchangeably.

To deal with some of the issues raised above, many studios have resorted to sharing the entire development process, in addition to the various collaterals being developed by the various groups, with the artists of all the groups irrespective of whether a given collateral is required by a given artist or not. However, with complex development projects, involving terabytes of data, such sharing of entire development process is limited by the communicator network's available data bandwidth. In most cases, the required data bandwidth are only available within intranet networks, forcing the studios to keep all their development work localized.

Even in instances where the development work of a digital product is performed across multiple remote studios, the remote studios are connected to each other by dedicated high speed data bandwidth network connections. Thus, the studios/artists working on the digital product are limited to those interconnected with each other by dedicated high speed data bandwidth network connections while excluding any studios/artists who are not interconnected by a dedicated high speed data bandwidth network connection.

### SUMMARY

Technology is disclosed for developing digital content in a distributed content production environment (“the technology”). In various embodiments, the technology receives a request from a client system to access media files associated with digital content, where the media files are to be used for performing a plurality of tasks. The request further includes an indication of a particular task to be performed by the client system. The technology determines a subset of media files used for performing the particular task. The subset of media files is determined by utilizing the dependency between the particular task and one or more assets to be used for performing the particular task. Dependency is determined based on the flow of data amongst the plurality of tasks used in developing the digital content (“the pipeline technology”). In various embodiments, the technology gathers the determined subset of media files and provides the client system access to the gathered subset of media files.

### BRIEF DESCRIPTION OF THE DRAWINGS

FIG. 1 is a block diagram illustrating a brief, general description of a representative environment in which the technology can be implemented in various embodiments.

FIG. 2 provides a flowchart of the various processes involved in the development of a segment of an animated movie.

FIG. 3 provides a block diagram of the process involved in compositing the various assets and shot developed for a given segment of the animated movie.

FIG. 4 provides an illustrative example of an asset container.

FIG. 5 provides an illustrative example of a shot container.

FIG. 6 provides additional details of an asset development process using the disclosed pipeline technology in the representative environment.

FIG. 7 is a flow diagram illustrating a method for developed digital content, consistent with various embodiments.

FIG. 8 is a flow diagram illustrating a method for developed digital content, consistent with various embodiments.

FIG. 9 illustrates one example of a client application

FIG. 10 illustrates one example of a client application that can be used to initiate creation of an asset, i.e. initiation of a particular task.

FIG. 11 illustrates one example of a client application that was used to create an asset in the asset library of the client application.

FIG. 12 illustrates one example of a client application in which empty file structures are created in the workspace for an asset created in the asset library of the client application.

FIG. 13 illustrates one example of a client application in which file structures are updated in the workspace for an asset created in the asset library of the client application, where one or more input files received from a content manager are stored in the client application.

FIG. 14 illustrates one example of a means of using a client application to checkout a component associated with an asset.

FIG. 15 illustrates one example of a means of using a client application to check-in a component associated with an asset.

FIG. 16 illustrates one example of a client application in which the version number of the component being accessed is displayed.

FIG. 17 illustrates one example of a client application which can be used to create a Release of an asset/shot for use in final production.

FIG. 18 illustrates one example of a client application providing a display of the various Releases available for a given asset/shot.

FIG. 19 illustrates one example of a client application providing the ability to recover a prior version of an asset/shot.

FIG. 20 is a block diagram of a computer system as may be used to implement features of some embodiments of the disclosed technology.

### DETAILED DESCRIPTION

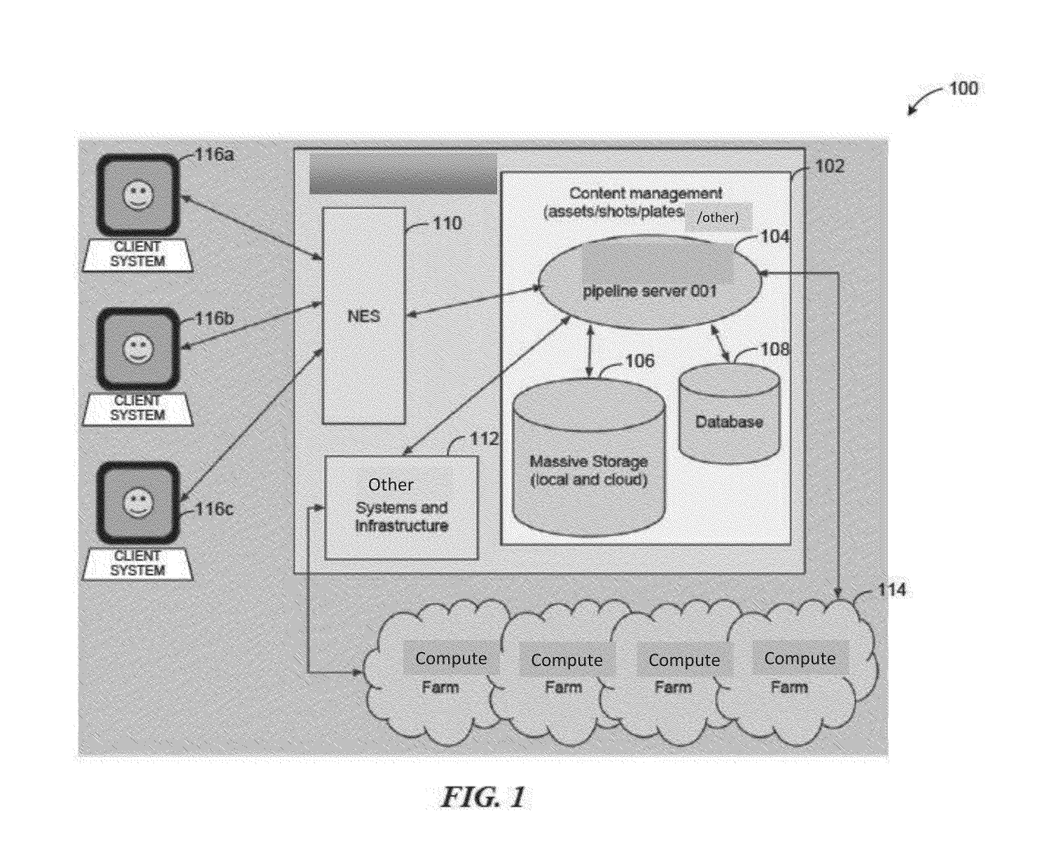

FIG. 1 is a block diagram illustrating a distributed digital content production environment 100 in which the disclosed technology may be implemented in various embodiments. The distributed digital content production environment 100 (“distributed environment”) includes several client systems 116a-116c; network service layer 110 that enables the client systems 116a-116c to interact with a content management system 102 through a communication network; other systems and infrastructure 112 used in development of digital content and a cloud crunch farm 114 that provides data processing resources for digital content development. In various embodiments, the distributed environment 100 can be used by an animation studio to develop digital content in a distributed manner. In various embodiments, the distributed environment 100 can be used by an animation school to teach students to work and develop digital content in a distributed manner.

In the distributed environment 100, the disparate processing devices are linked through the communications network, e.g. a Local Area Network (LAN), Wide Area Network (WAN), the Internet, etc. In some instances, the communications network is the Internet, allowing the client systems 116a-116c to access the content management system 102 through various web servers. In some instances, the communication network may be any type of cellular, IP-based or converged telecommunications network.

In some embodiments, the content management system 102 further includes a pipeline server 104, a database 108 and massive storage 106. In some embodiments, the pipeline server 104 manages the various media files (e.g., assets such as props, characters, sets; models of assets, shadings of assets, rigs of assets, etc.) used in the development of digital content. In some embodiments, the pipeline server 104 serves as a centralized location for managing the various media files, where the pipeline server 104 utilizes a database 108 to store and manage the various media files. For example, when a client system 116a-116c wishes to access a media file stored within the content management system 102, the client system 116a-116c interfaces with the pipeline server 104 to access the media the stored in the database 108.

In some embodiments, the massive storage 106 includes local and cloud based data storage resources, providing the content management system 102 with additional storage resources to store the various media files and other intermediate files generated during production of digital content, e.g., data generated by other systems and infrastructure 112 used in development of digital content. In some embodiments, the other systems and infrastructure 112 include compositing engines, rendering engines, etc., that are used in development of digital content using the media files stored and other data files stored in the content management system 102. The other systems and infrastructure 112 utilize the processing resources provided by the cloud crunch farms 114 and the media files available through the pipeline server 104 to perform various aspects of the digital content development process.

In various embodiments, the distributed environment 100, implementing the disclosed pipeline technology, can enable distributed development of media files associated with various processes used in the development of digital content. The digital content, developed using the disclosed pipeline technology, includes animated movies, games, commercials, cover photos, models and rigs, music, etc., where the pipeline technology allows for distributed development of such content. For the purpose of illustrating how the pipeline technology could be utilized in the development of digital content, the following discussion focuses on using the pipeline technology for developing animated movies. The various techniques and processes used in development of animated movies could also be used in the development of other types of digital content and should not be considered limited to development of animated movies. In some embodiments, the digital content being developed could be an animated movie, where the assets, i.e. one of the media files, developed in one or more client systems 116a-116c can be used in the production of the animated movie. In some embodiments, the various processes involved in the development of each segment of the animated movie can be performed in a distributed manner within the distributed environment 100. In some embodiments, various tasks associated with each of the processes involved in the development of a given segment of the animated movie can be performed in a distributed manner within the distributed environment 100.

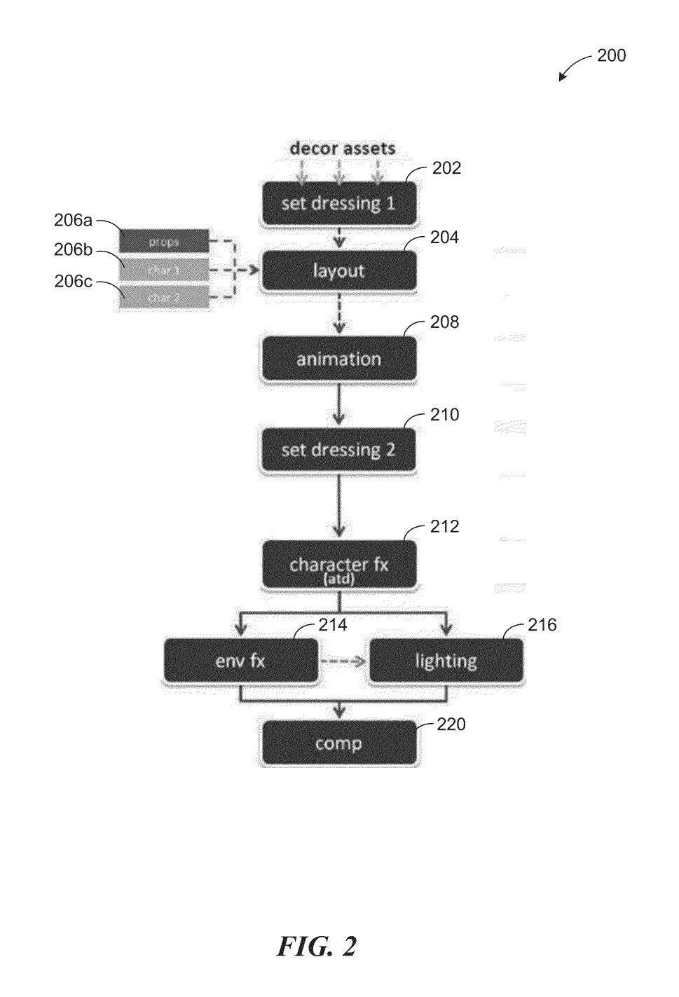

Turning briefly to FIG. 2, FIG. 2 provides a flowchart 200 of the various processes involved in the development of a segment of an animated movie. In block 202, a first set dressing process is performed. In the first set dressing process, a set and various décor pieces are assembled to create a set type asset (“set asset”), which could be used in the layout process performed in block 204. A set is a virtual representation of a physical space, e.g. walls, floors, doors, etc., composed on set pieces, where each piece is an individual file with geometry modeled at the proper places in the world-space geometry.

Further, décor pieces are those items that are placed on a set that will not be for interaction, e.g. pictures, furniture, etc. Here, the segment of the animated movie is staged within this set asset. So, in block 202, the first set dressing process depends on a set file and various décor file as input to generate the set asset, implying a dependency for performing the particular process, i.e. task, in the development of a segment of an animated movie. As discussed above, the disclosed technology, implemented within the distributed environment 100, utilizes the knowledge of the various dependencies and the associated media files to enable development of animated content in a distributed environment 100.

In block 204, a layout process is performed. In the layout process, various assets, e.g. characters, props, etc., are placed within the set asset and the camera angles, camera paths, lighting, and shading of the segment of the animated movie is determined to create a layout type asset (“layout asset”). Further, for character assets, the major poses for the characters in the segment of the animated movie are determined, forming part of the layout asset. So, in block 204, the layout process depends on a set asset, character assets, prop assets, etc., to create a “layout” asset, implying a dependency for performing the particular process (i.e. task) in the development of a segment of an animated movie. It should be noted that each asset, e.g., characters, props, etc., is itself rendered using various components, where each component is developed by performing various tasks. Further, development of some of the components, e.g. rig, associated with a given asset utilizes other components (e.g., model) of the given asset, creating dependencies within the various tasks performed in the development of the given asset.

In block 206, an animation process is performed. In the animation process, animation sequences are added to one or more characters included within the segment of the animated movie. The animation process utilizes the layout asset, the character assets 206b, 206c, the prop assets 206a, etc., to develop an animation sequence, creating the animation type asset (“animation asset”) of the segment of the animated movie. Further, in block 208, a second set dressing is performed. In the second set dressing, utilizing the newly created animation assets and the various other assets that form part of the segment of the animated movie, the set asset is adjusted to ensure the assets that part of the segment of the animated movie interact appropriately, e.g. when a décor piece improperly blocks a character asset, the décor piece is rearranged within the set asset.

In block 212, utilizing the character assets and the related animation assets, special effects applied to the character assets are created as character fx type assets (“character fx assets”). In block 214, utilizing the character fx assets and other assets created in the previous processes, environmental effects that are applied to the segment of the animated movie are created as env fx type assets (“env fx asset”). In block 216, utilizing the character fx assets and other assets created in the previous processes, lighting effects that are applied to the segment of the animated movie are created as lighting type assets (“lighting assets”). In block 220, the various assets developed in each of the processes is combined into one single image (also known as compositing), creating a segment of the animated movie. Finally, the various assets developed in each of the processes for the segment of the animated movie forms a shot, allowing a given shot to be managed as a unit of production during the development of the animated movie.

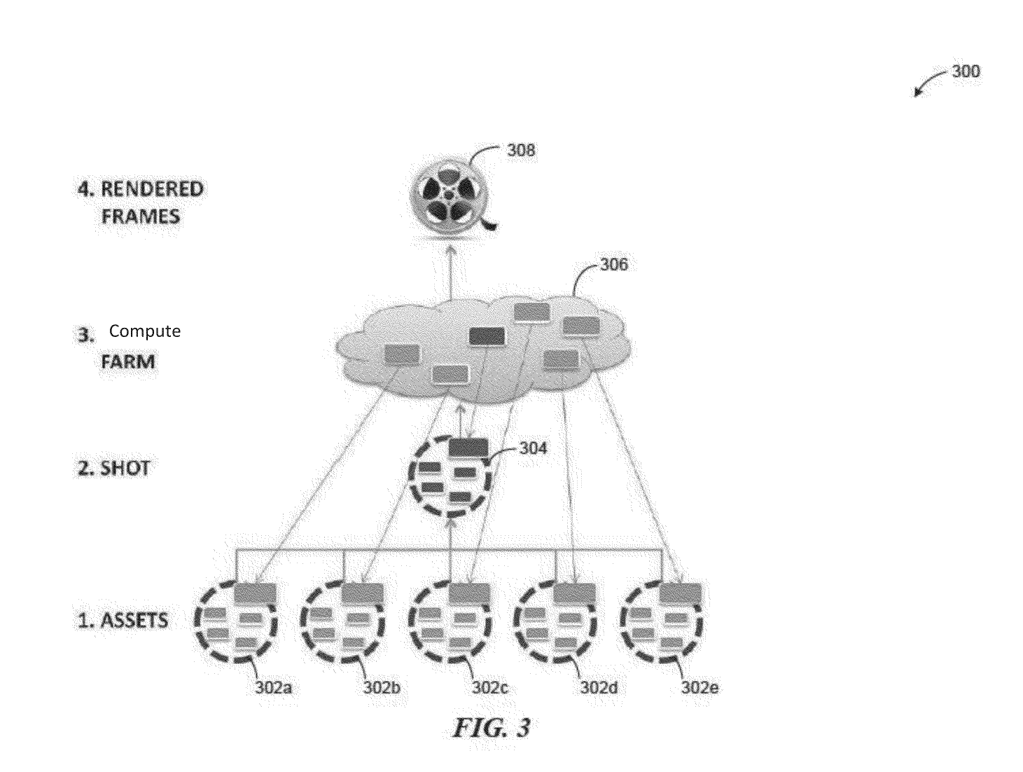

Turning briefly to FIG. 3, FIG. 3 provides a block diagram of the process 300 involved in compositing the various assets and shot developed for a given segment of the animated movie (using the processes described in FIG. 2) to render one or more digital frames of the given segment of the animated movie. As discussed above, the assets 302a-302e could include all the assets, e.g. the characters 302a, 302b, the props 302c, 302d, the set, 302e, etc., which were used as input in the flowchart 200 to develop the various other assets that form the shot 304 of the given segment of the animated movie. When compositing, the various assets 302a-302e used to create the shot and the assets included with the shot are used to render all the models and animation that form the given segment of the animated movie in a render farm 306, e.g. the cloud crunch farm 114. The rendered models are then composited to form complete images that form part of the given segment of the animated movie. Finally, digital frames 308 corresponding to the given segment of the animated movie are created from the composited images generated in the render farm.

Returning to FIG. 1, the pipeline technology, implemented within the distributed environment 100, utilizes the knowledge of the dependencies amongst the various content development processes to enable development of animated content in a distributed environment 100. In some embodiments, the pipeline server 104 implements the disclosed pipeline technology to manage the dependencies between the various tasks performed during the content development process and the associated media files, e.g. assets, shots, etc., stored within the database 108, used by the various tasks. Based on the dependencies between the various tasks, the pipeline server 104 enables the flow of media files from one stage of the production to the other, until the final composition of the animated movie is completed using the various media files generated at the various stages of the production. In various embodiments, the pipeline server 104 utilizes a version manager (e.g., perforce) to manage multiple versions of a given media file within the database 108 of the content management system 102.

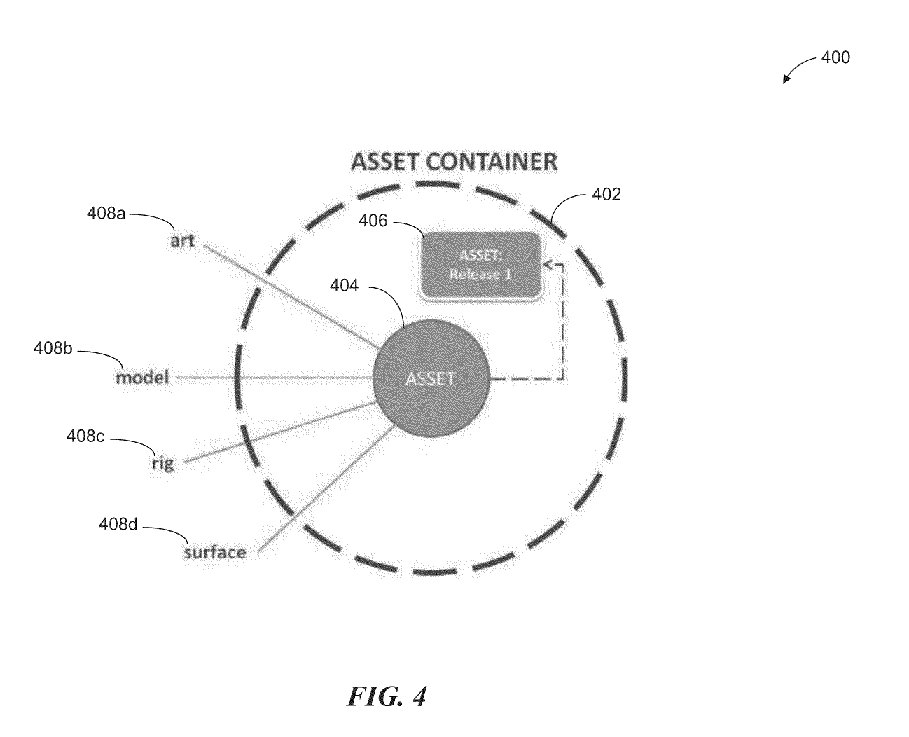

In some embodiments, the pipeline server 104 manages the various assets associated with an animated movie in an asset library, allowing for simpler management of the dependency between the stored assets and the various tasks that utilize the stored assets. The asset library stores the various assets developed during the production of the animated movie and the associated components, e.g. rigs, model, shading, etc., used to render the assets within the asset library. In some embodiments, the asset library stores the assets as asset containers, where each asset container includes a corresponding asset and components associated with the asset. FIG. 4 provides an illustrative example 402 of an asset container 400 that includes the various components (art 408a, model 408b, rig 408c, surface 408d) associated with the asset 404 and the version 406 of the asset 404 included within that particular asset container 400.

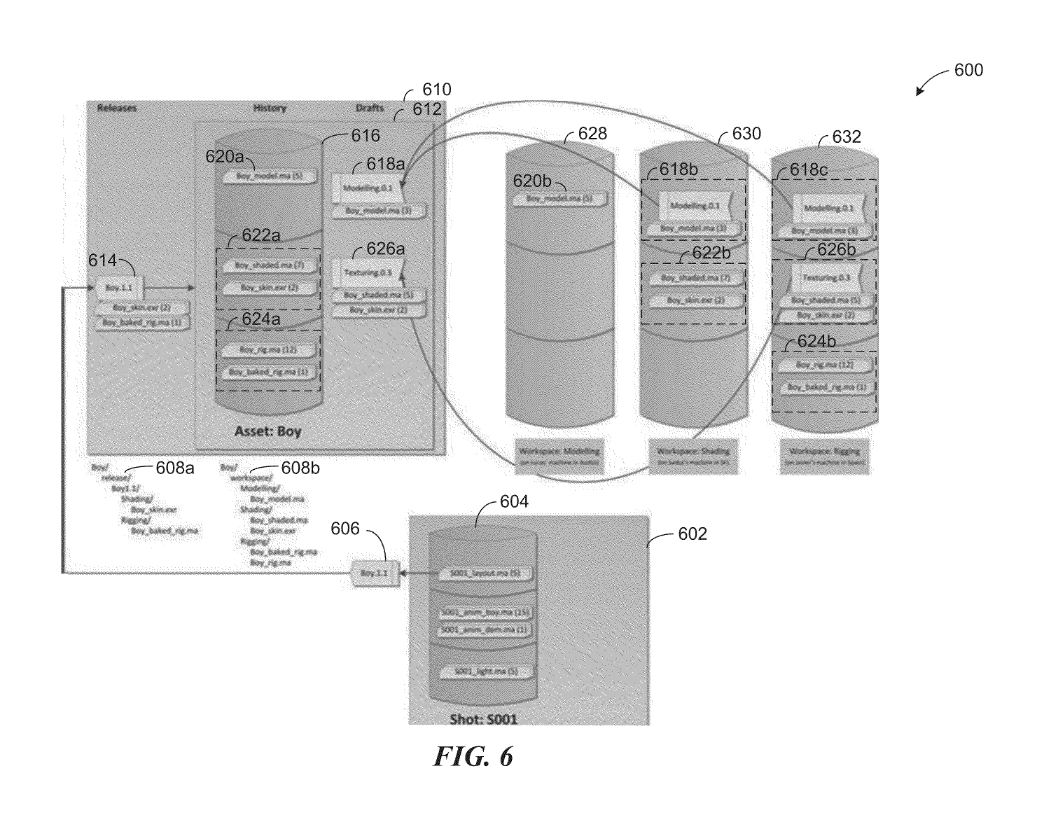

As discussed above, various tasks that utilize stored assets include tasks that involve development of some of the components, e.g. rig, associated with a given asset. For example, development of the rig component for a given asset utilizes the model component of the asset. By storing the asset and its components in an asset container, the pipeline server 104 can quickly identify the input component file(s) needed by a particular component development task. FIG. 6 provides additional details of an asset development process using the disclosed pipeline technology in the distributed environment 100.

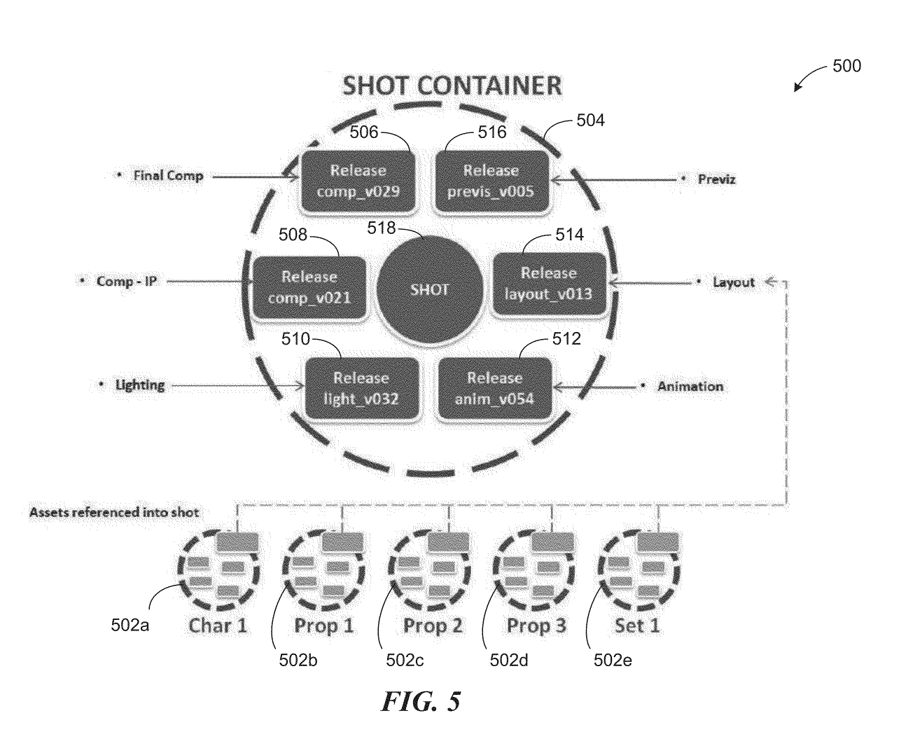

In some embodiments, the pipeline server 104 manages the various shots associated with an animated movie in a shot library, allowing for simpler management of the dependency between the stored shots and the various tasks that utilize the stored shots. Similar to the asset container, the shot library utilizes shot container to store the assets a shot is composed of. FIG. 5 provides an illustrative example 504 of a shot container 500 that includes the various assets (final composition 506, composition 508, lighting 510, animation 512, layout 514, previs 516) the shot 518 is composed of and the respective versions of the various assets included within the particular shot container 500. Further, as discussed above, the layout asset 514 includes references to the various assets, e.g., characters 502a, props 502b-502d, sets 502e, which were used in the development of the layout asset 514.

As discussed above, various tasks that utilize assets composed within a shot include tasks that involve development of other assets associated with the shot. For example, as discussed above, development of animation asset for a given shot utilizes the layout component of the shot. By storing the shot and its various assets in a shot container, the pipeline server 104 can quickly identify the input asset file needed by a particular asset development task.

In various embodiments, the pipeline server 104 enables the development of various assets and shots of an animated movie in the distributed environment 100. The development can be performed in remote client systems 116a-116c that utilize the content management system 102 as a centralized manager of assets and shots to sync and exchange data when performing tasks that require the assets and/or shots being developed in another remote client system 116a-116c.

In some embodiments, when the pipeline server 104 receives a request from a client system 116a-116c that indicates that the client system 116a-116c is being used to perform a particular task, the pipeline server 104 utilizes the disclosed pipeline technology to determine the dependency between the particular task and the various input files required to perform the particular task. In some embodiments, the pipeline server 104 further determines the related asset the particular task is being performed for and identifies the asset/shot container associated with the related asset. Utilizing the versions of the various files included within the asset/shot container and the subset of input files required for performing the particular task, the pipeline server 104 gathers the required subset of input files from the database 108 and provides the client system 116a-116c with the gathered subset of input files.

In some embodiments, the client system 116a-116c copies the provided subset of input files to the client system 116a-116c. In some embodiments, the client system 116a-116c creates empty files/file structures for files that might have been requested but not provided by the pipeline server 104, where such empty files/file structures, unrelated to the particular task, are being used by the client system 116a-116c. It should be noted that the function of creating empty files is not limited to creating files with no information. In some embodiments, the function of creating empty files for those files that were not provided includes the creation of only directories and directory hierarchies associated with those requested but not provided files. In some embodiments, when a particular task is being performed by a client system 116a-116c and the particular task involves generation of an asset, the pipeline server 104 checks out the asset to the particular client system 116a-116c performing the particular task, preventing other client systems 116a-116c from accessing or interfering with the checked out asset.

In some embodiments, when the checked out asset is checked back in, the asset becomes available for others performing the particular task that involves generation of the asset from accessing the asset. In some embodiments, when a client system 116a-116c completes development of a particular asset and the particular asset is approved for use by other artists, the client system 116a-116c can make a Release of the particular asset for use by other client systems 116a-116c that are performing tasks that utilize the particular asset as an input. The Release is immutable and contains a specific set of versions of a specific set of files, associated with a given asset, which may be referenced without risk of change.

In some embodiments, when a client system 116a-116c is still working on generation of a particular asset, the particular asset is checked out to a workspace and the pipeline manager 104 prevents other client systems 116a-116c from modifying the particular asset checked out in the workspace.

In some embodiments, when a client system 116a-116c is still working on generation of a particular asset, the particular asset can be saved as a draft, allowing other client systems 116a-116c to utilize the particular asset at the draft revision with the notification that the particular asset is subject to revision.

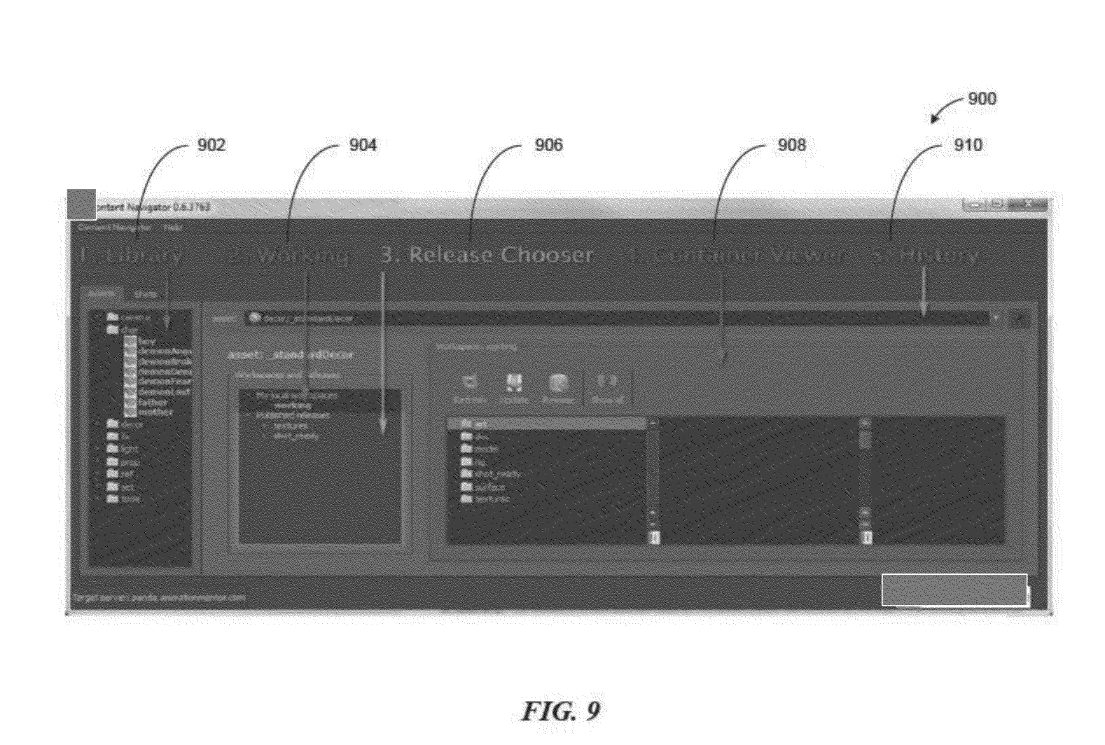

Other features supported by the pipeline server 104, in various embodiments, which allows easy integration of the assets/shots developed by the client systems 116a-116c with each other to create a finished work product is discussed with reference to FIG. 9 through FIG. 19.

FIG. 6 provides additional details of an asset development process using the disclosed pipeline technology in the distributed environment 100. In FIG. 6, the distributed development of one or more assets composed within a particular version 604 of a shot 602 in the distributed environment 100 is provided. The shot 604 includes a layout asset which references an asset Boy 606 (version 1.1). The shot further includes a couple of animation assets and a lighting asset.

The pipeline manager 104 further maintains a Release version and a workspace version of the asset Boy 606 within the database 108, each with their own respective on-disc directory structures 608a, 608b. Further, the Release version 614 of the asset Boy 606 only includes a portion of the shading component (i.e. Boy_skin.exr) and a portion of the rig component (i.e. Boy_baked_rig.ma) but no model component. The workspace version 616 of the asset Boy 612, maintained by the pipeline manager 104, includes a version of model component 620a, a version of texturing component 622a and a version of rigging component 624a. The draft version of the asset Boy 612, maintained by the pipeline manager 104, includes a version of the modeling component 618a and a version of the texturing component 626a.

In FIG. 6, the asset file Boy_shaded.ma (622b) references the Modeling 0.1 Release (618a), which is invariant. Subsequent changes made to the file Boy_model.ma (620a) have no impact on the Modeling 0.1 Release (618a) and therefore no impact on Boy_shaded.ma (622b), until such time as a new “Modeling” Release is created and referenced by Boy_shaded.ma (622b).

In FIG. 6, the asset file Boy_rig.ma (624b) references the Texturing 0.3 Release (626a), which is invariant. Subsequent changes made to the file Boy_shaded.ma (622b) have no impact on the Texturing 0.3 Release (626a) and therefore no impact on Boy_rig.ma (624b), until such time as a new “Texturing” Release is created and referenced.

In FIG. 6, the pipeline manager 104 enables three different client systems 628-632 to work on the three different components, i.e. model component, texture component and rigging component, of the asset Boy 612, respectively. The pipeline manager 104 enables distributed content development by identifying the input dependencies of each task performed during development and the appropriate subset of component files, stored within the database 108, to be provided to the appropriate client system based on the task being performed by the client system.

For example, in FIG. 6, the client system 628, located in Austin, Tex., performs generating the model component of the asset Boy 612. As discussed earlier, the model component of a given asset serves as the input for generating other components associated with the given asset and the model component requires none of the other components as input. The pipeline server 104, therefore, simply allows the client system 628 to check out the version of model component stored in workspace 620a and copy 620b it to the client system 628 to work on the model component. The pipeline server 104 does not provide the client system 628 with any of the other components or assets, allowing the client system 628 to maintain empty files in place of those assets/components not provided.

The client system 630, located in SF, CA, performs generating texture component of the asset Boy 612. For the generation of texture component of a given asset, the task requires the model component of the given asset to be used as input. Given that the client system 630 does not have access to the version of the model component in the workspace 616, the pipeline server 104 copies a draft of the model component 618a to the client system as model component 618b.

Further, given that the client system 630 is performing the task of texture component generation, the pipeline server 104 checks out the version of texture component stored in workspace 622a and copies 622b it to the client system 630 to work on the texture component. The pipeline server 104 does not provide the client system 630 with any of the other components or assets, allowing the client system 630 to maintain empty files in place of those assets/components not provided. In some embodiments, the pipeline server 104 utilizes available Release version of the various input files and utilizes draft version of the various input files only when Release versions are unavailable.

The client system 632, located in Spain, performs generating rigging component of the asset Boy 612. For the generation of rigging component of a given asset, the task requires both the model component and texture component of the given asset to be used as inputs. Given that the client system 632 does not have access to the version of the model component and texture component in the workspace 616, the pipeline server 104 copies a draft of the model component 618a and texture component 626a to the client system as model component 618b and texture component 626b, respectively.

Further, given that the client system 632 is performing the task of rig component generation, the pipeline server 104 checks out the version of rig component stored in workspace 624a and copies 624b it to the client system 632 to work on the rig component. Thus, by identifying the input dependencies of each task performed during development and the appropriate subset of component files, the pipeline manager 104 enables distributed content development amongst three different client systems 628-632 deployed across a wide geography without an interconnecting dedicated high-speed communication network.

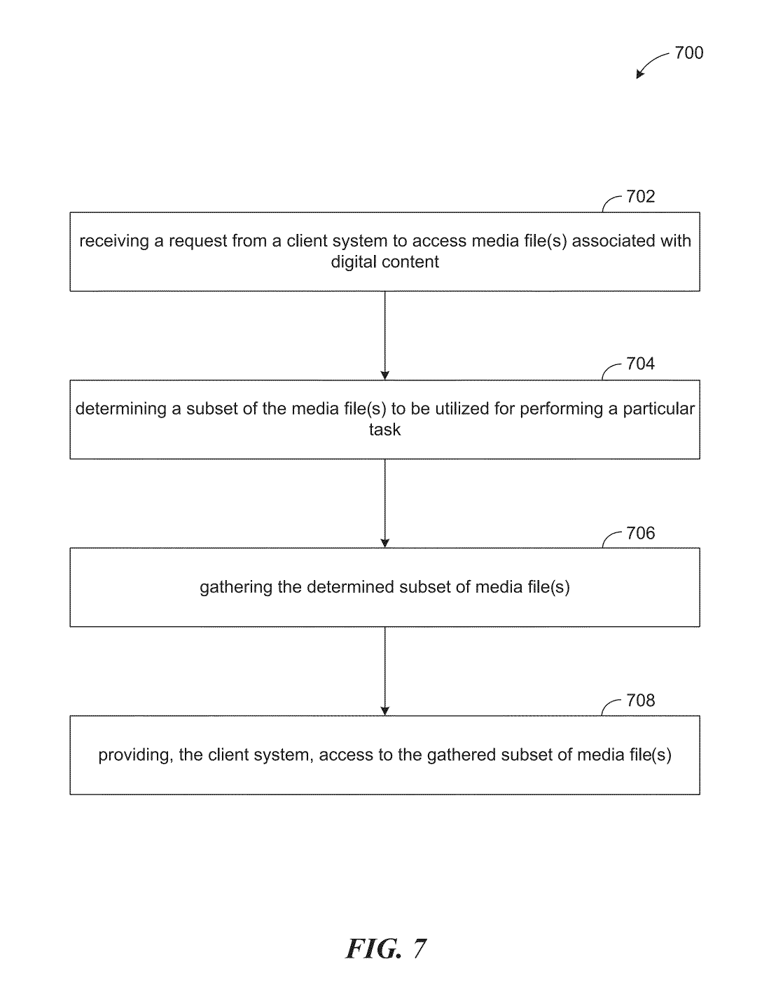

FIG. 7 is a flow diagram illustrating a method 700 for developed digital content, consistent with various embodiments. In various embodiments, the method 700 may be executed in a distributed environment, e.g., distributed environment 100 of FIG. 1. The method 700 starts at block 702. At block 702, a request is received from a client system to access media files associated with digital content, where the media files are to be used for performing a plurality of tasks. In some embodiments, the request includes an indication of a particular task to be performed by the client system.

At block 704, a subset of the media files to be used for performing a particular task is determined. In some embodiments, the dependency between the particular task and one or more assets to be used for performing the particular task is determined based on the flow of data amongst the plurality of tasks used in developing the digital content. In some embodiments, a corresponding version of the each of the assets to be used for performing the particular task is identified, where the identified version of each of the one or more assets form the subset of identified media files.

At block 706, the determined subset of media files is gathered. In some embodiments, gathering a given media file includes retrieving the given media file from the database 108. At block 708, the client system is provided access to the gathered subset of media files. In some embodiments, providing access includes allowing the client system to copy the gathered subset of media files to its system.

Those skilled in the art will appreciate that the logic illustrated in FIG. 7 and described above, and in each of the flow diagrams discussed below, may be altered in various ways. For example, the order of the logic may be rearranged, substeps may be performed in parallel, illustrated logic may be omitted, other logic may be included, etc.

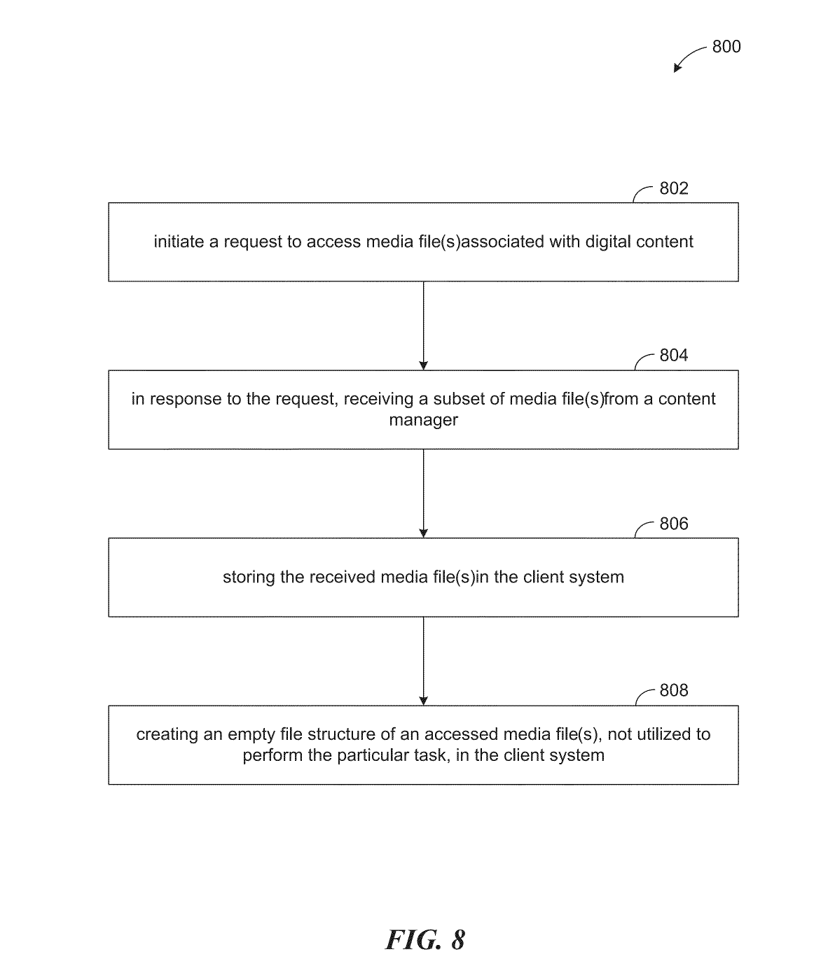

FIG. 8 is a flow diagram illustrating a method 800 for developed digital content, consistent with various embodiments. In various embodiments, the method 800 may be executed in a distributed environment, e.g., distributed environment 100 of FIG. 1. The method 800 starts at block 802. At block 802, a request is initiated to access media files associated with digital content. In some embodiments, such a request can be initiated from a client system 116a-116c. At block 804, in response to the request, a subset of media files is received from a content manager. At block 806, the received media files are stored in the client system. At block 808, an empty file structure is created in the client system for an accessed media file not included in the subset of media files received by the client system.

FIG. 9 illustrative one example of a client application 900, which can be installed in the client systems 116a-116c, to enable the client systems 116a-116c to interact with the content management system 102 and access the various assets/shots managed by the content management system 102. In some embodiments, the client application 900 can be installed as a plugin with digital content development tools, e.g., Maya, where the digital content developed using the tool can be stored in the content management system 102 through the client application 900. Further, the content stored in the content management system 102 can be accessed and edited within the development tool using the client application 900.

In FIG. 9, as discussed above, the client application 900 provides the assets and shots as separate libraries 902. Further, each asset includes a workspace 904 and a Release area 906. The client application 900 also provides a container view of the selected asset within the container viewer 904 of the client application 900, where the container view includes the various components associated with the selected asset. The client application 900 also includes a history menu 910 to access version history of the selected asset/shot.

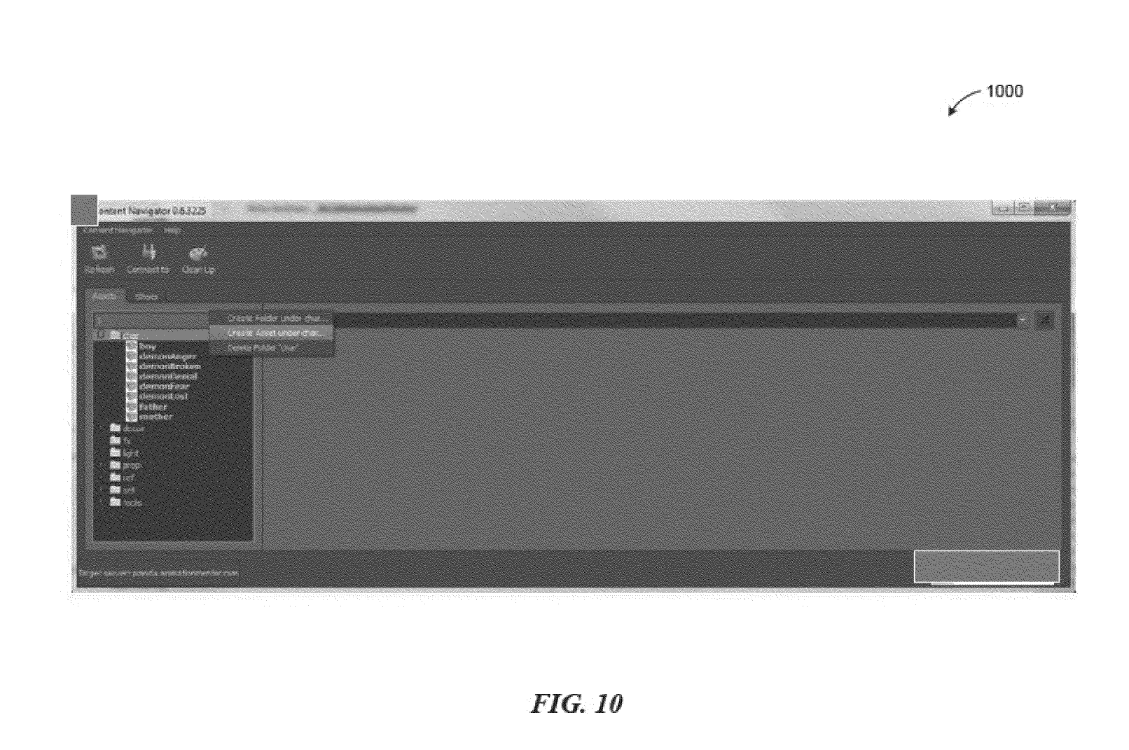

FIG. 10 illustrative one example of a client application 900 that can be used to initiate creation of an asset 1000 (i.e. initiation of a particular task).

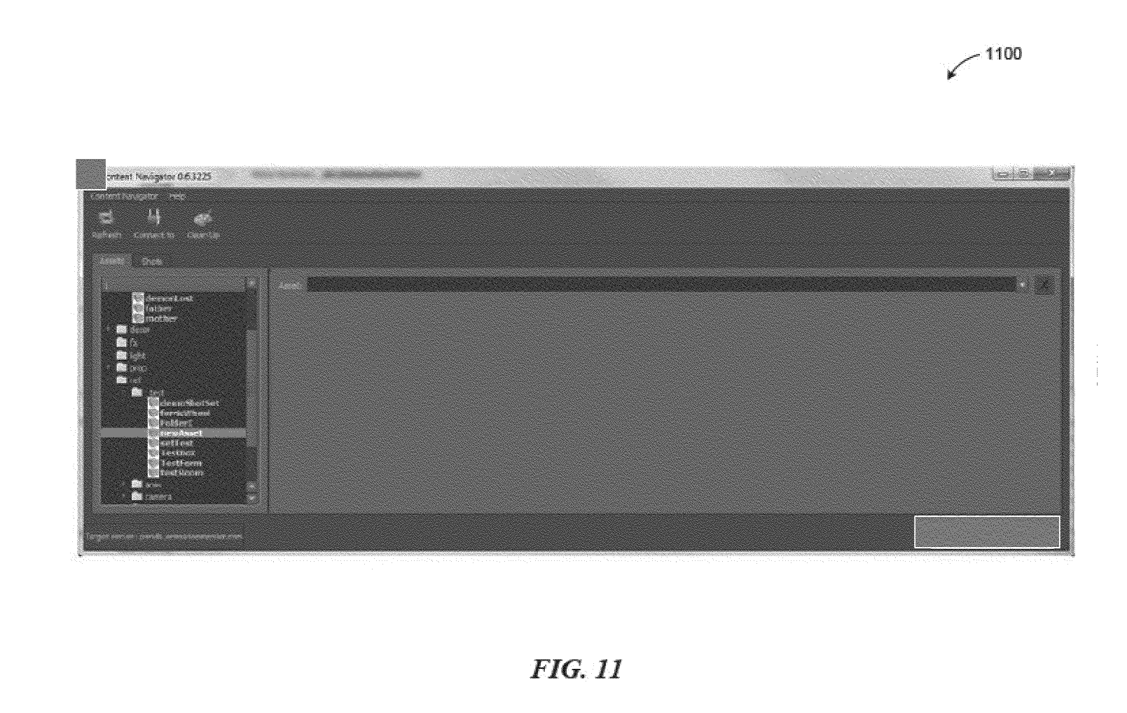

FIG. 11 illustrates one example of a client application 900 that was used to create an asset 1100 in the asset library of the client application 900.

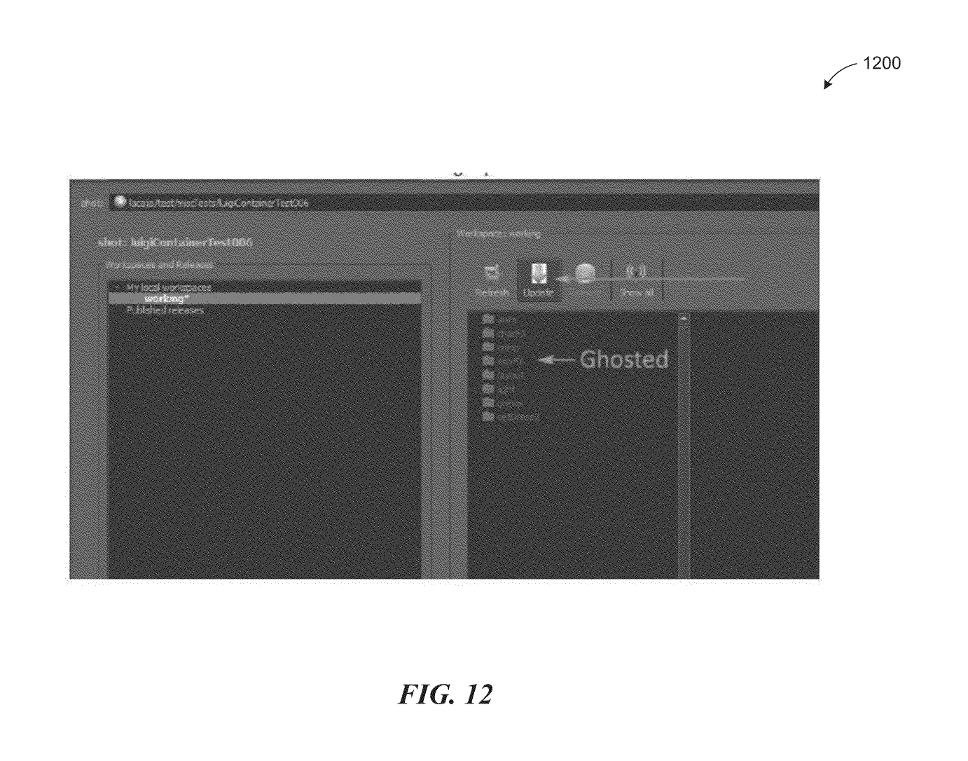

FIG. 12 illustrates one example of a client application 900 in which empty file structures 1200 are created in the workspace for an asset created in the asset library of the client application 900.

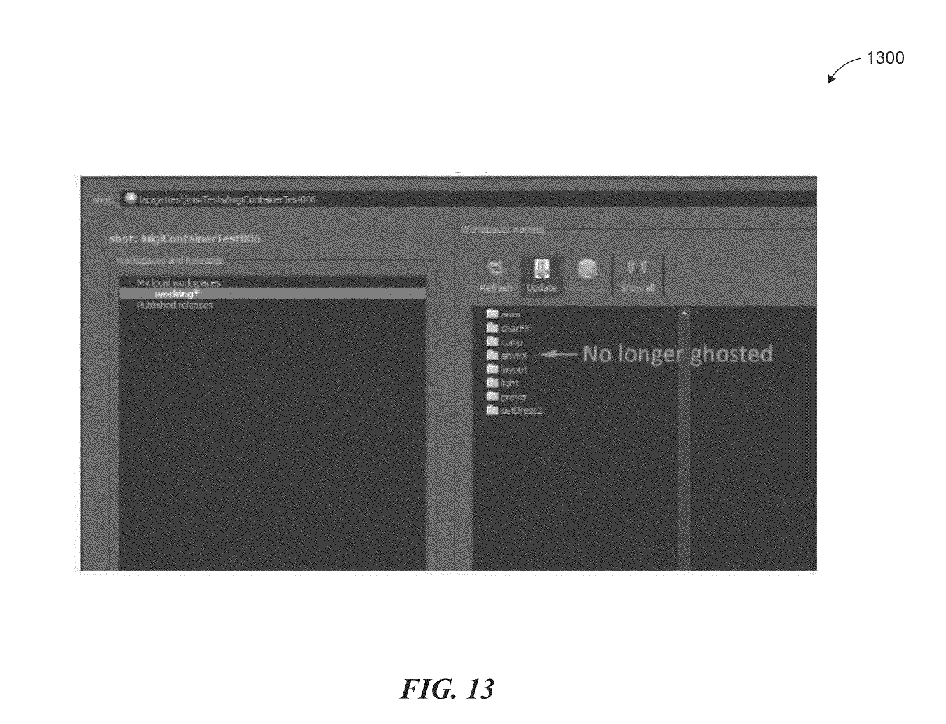

FIG. 13 illustrates one example of a client application 900 in which file structures 1300 are updated in the workspace for an asset created in the asset library of the client application 900, where one or more input files received from a content manager are stored in the client application 900.

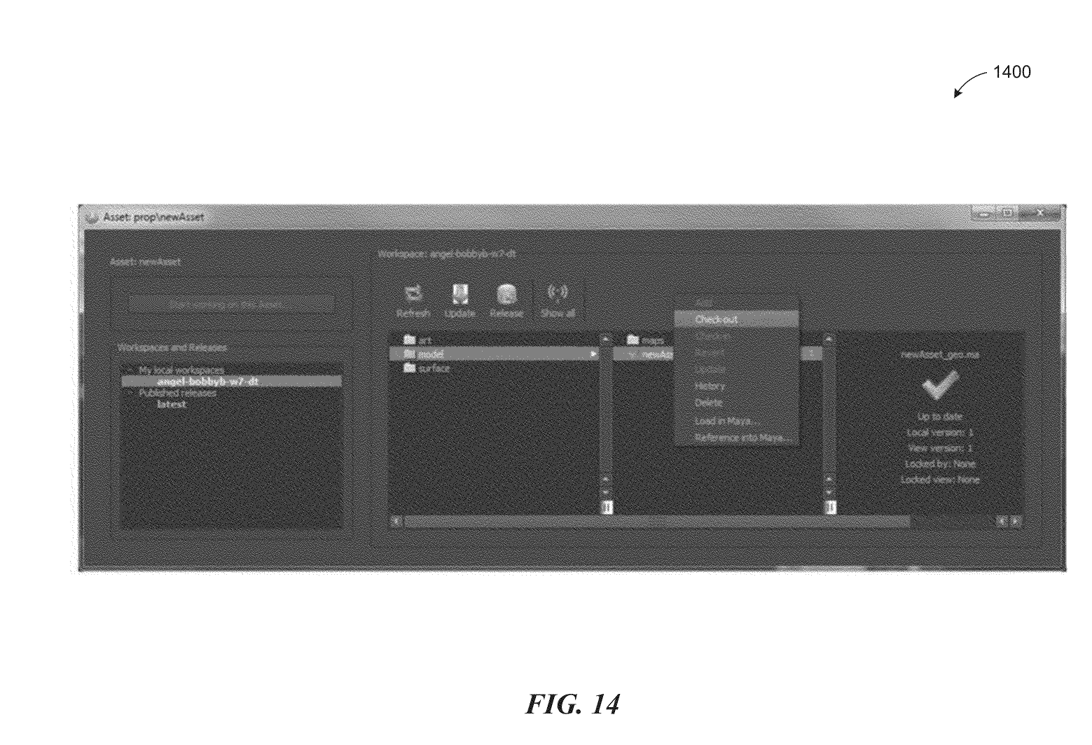

FIG. 14 illustrates one example of a means of using a client application 900 to checkout 1400 a component associated with an asset.

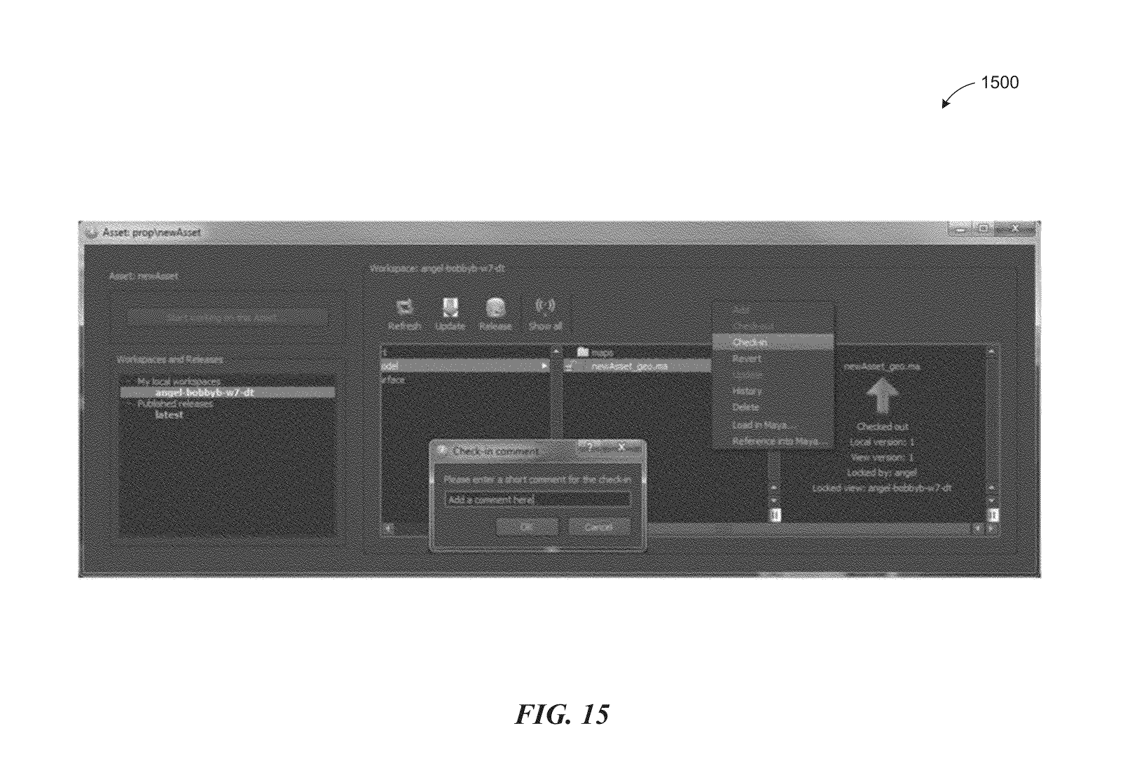

FIG. 15 illustrates one example of a means of using a client application 900 to check-in 1500 a component associated with an asset.

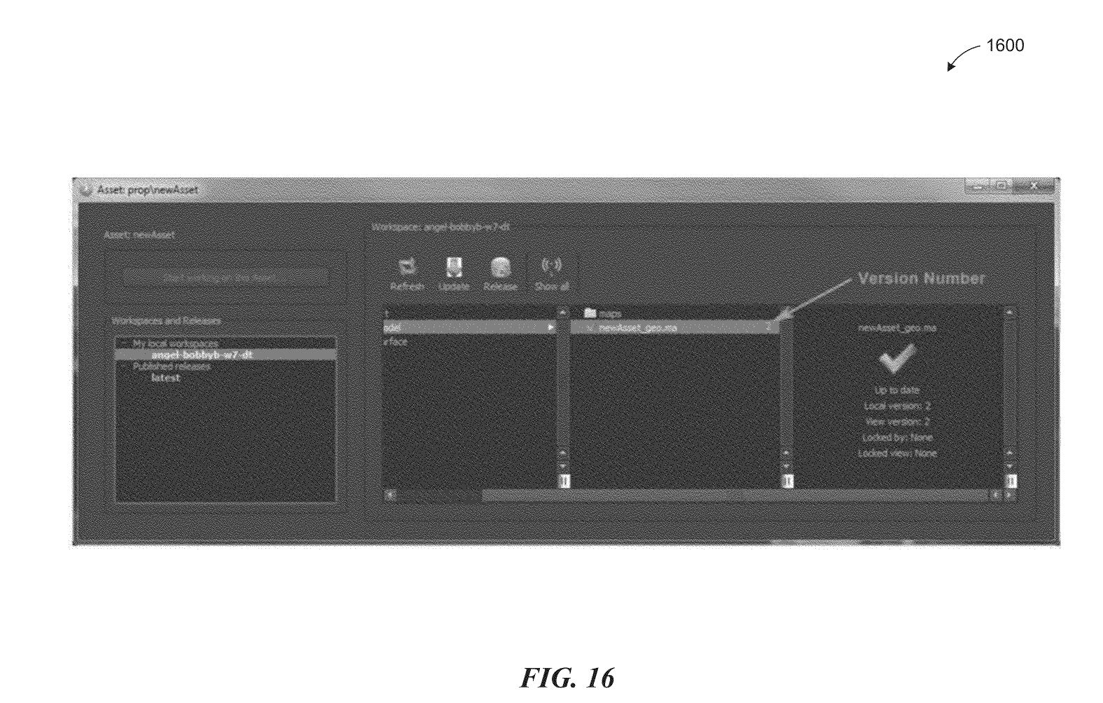

FIG. 16 illustrates one example of a client application 900 in which the version number 1600 of the component being accessed is displayed.

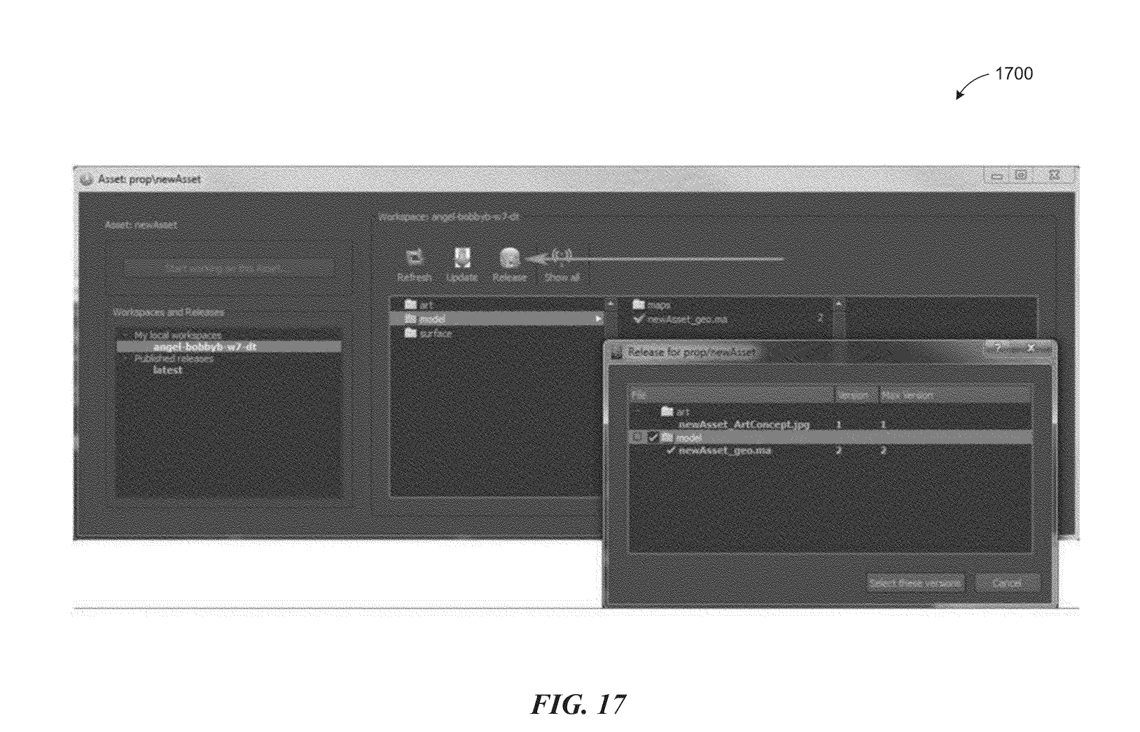

FIG. 17 illustrates one example of a client application 900 which can be used to create a Release 1700 of an asset/shot for use in final production.

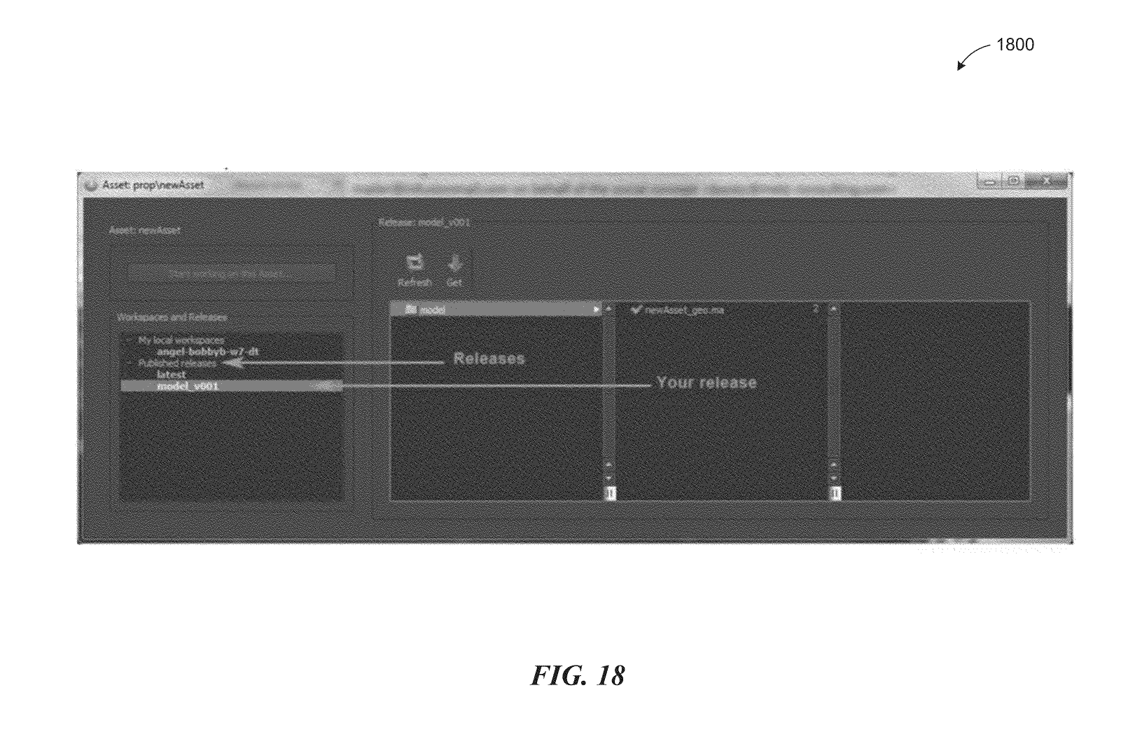

FIG. 18 illustrates one example of a client application 900 providing a display of the various Releases 1800 available for a given asset/shot.

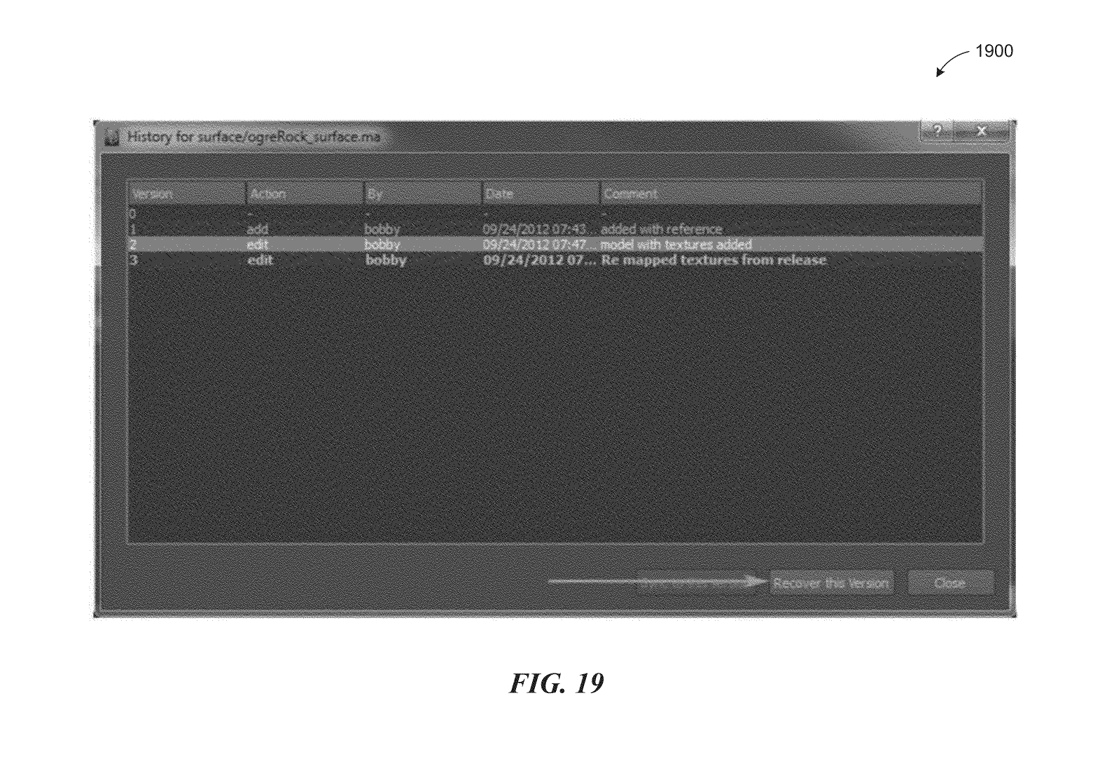

FIG. 19 illustrates one example of a client application 900 providing the ability to recover 1900 a prior version of an asset/shot.

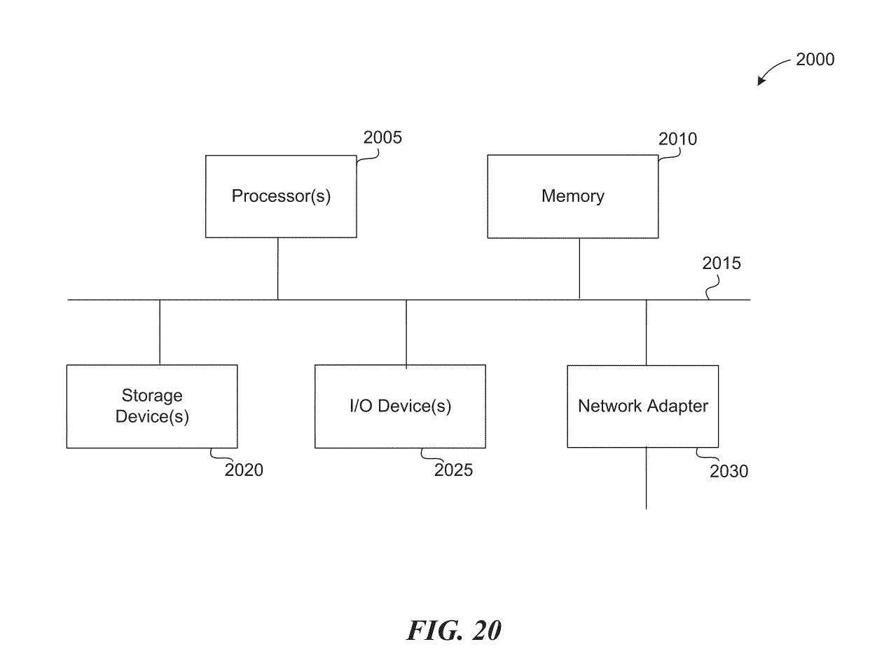

FIG. 20 is a block diagram of a computer system as may be used to implement features of some embodiments of the disclosed technology. The computing system 2000 may include one or more central processing units (“processors”) 2005, memory 2010, input/output devices 2025 (e.g., keyboard and pointing devices, display devices), storage devices 2020 (e.g., disk drives), and network adapters 2030 (e.g., network interfaces) that are connected to an interconnect 2015. The interconnect 2015 is illustrated as an abstraction that represents any one or more separate physical buses, point to point connections, or both connected by appropriate bridges, adapters, or controllers. The interconnect 2015, therefore, may include, for example, a system bus, a Peripheral Component Interconnect (PCI) bus or PCI-Express bus, a HyperTransport or industry standard architecture (ISA) bus, a small computer system interface (SCSI) bus, a universal serial bus (USB), HO (I2C) bus, or an Institute of Electrical and Electronics Engineers (IEEE) standard 1394 bus, also called “Firewire”.

The memory 2010 and storage devices 2020 are computer-readable storage media that may store instructions that implement at least portions of the described technology. In addition, the data structures and message structures may be stored or transmitted via a data transmission medium, such as a signal on a communications link. Various communications links may be used, such as the Internet, a local area network, a wide area network, or a point-to-point dial-up connection. Thus, computer readable media can include computer-readable storage media (e.g., “non transitory” media) and computer-readable transmission media.

The instructions stored in memory 2010 can be implemented as software and/or firmware to program the processor(s) 2005 to carry out actions described above. In some embodiments, such software or firmware may be initially provided to the processing system 2000 by downloading it from a remote system through the computing system 2000 (e.g., via network adapter 2030).

The technology introduced herein can be implemented by, for example, programmable circuitry (e.g., one or more microprocessors) programmed with software and/or firmware, or entirely in special-purpose hardwired (non-programmable) circuitry, or in a combination of such forms. Special-purpose hardwired circuitry may be in the form of, for example, one or more ASICs, PLDs, FPGAs, etc.

### REMARKS

The above description and drawings are illustrative and are not to be construed as limiting. Numerous specific details are described to provide a thorough understanding of the disclosure. However, in certain instances, well-known details are not described in order to avoid obscuring the description. Further, various modifications may be made without deviating from the scope of the invention. Accordingly, the invention is not limited except as by the appended claims.

1. A computer implemented method of developing digital content, comprising:
receiving a request from a client system to access media files associated with digital content, the media files to be used for performing a plurality of tasks, the request including an indication of a particular task to be performed by the client system, wherein the media files include one or more of: an asset and an asset container including one or more components associated with a given asset;
determining a subset of the media files to be used for performing the particular task;
gathering the determined subset of media files; and
providing, the client system, access to the gathered subset of media files, wherein a plurality of loosely affiliated client systems, including the client system, distributed across geographically dispersed locations, are in communication with each other via a public network with a general level of interconnectivity.

2. The method of claim 1, wherein providing access to the client system includes allowing the media files to be copied to the client system.

3. The method of claim 2, wherein an empty file structure for an accessed media file not being provided to the client system is created in the client system.

4. The method of claim 2, wherein the media files associated with digital content are managed by a content manager, the content manager storing the media files in a database associated with the content manager, the content manager utilizing a version control manager to manage multiple versions of a given media the stored within the database.

5. The method of claim 4, wherein a portion of the media files, managed by the content manager, is generated by one or more client systems, wherein a given client system generates the given media the by performing a given task associated with the given client system, the one or more client systems sharing the media files generated by each other by utilizing the content manager, wherein the given client system is a remote computing system connected to the content manager through a network connection.

6. The method of claim 1, wherein the media files further include one or more of:
a component associated with the given asset;
a shot, the shot including one or more assets;
a shot container including one or more sub-media files associated with a given shot; and
a shot sequence.

7. The method of claim 6, wherein a given component included within the given asset includes one or more of:
an art of the given asset;
a model of the given asset;
a rig of the given asset; and
a surface of the given asset.

8. The method of claim 6, wherein the asset includes one or more of:
a character;
a prop used by the character; and
a set within which the animated character and the prop are placed in the given shot.

9. The method of claim 6, wherein a given sub-media file included within the given shot includes one or more of:
a lighting associated with the given shot;
an animation associated with the assets of the given shot;
a previs of the assets included in the given shot; and
a layout of the given shot.

10. The method of claim 1, wherein the plurality of tasks include one or more of:
modeling a given asset included within a given shot;
shading the given asset;
rigging the given asset;
creating previs for the given asset; and
animating the given asset.

11. The method of claim 6, wherein determining the subset of media files includes:
determining a dependency between the particular task and one or more assets to be used for performing the particular task, the dependency determined based on a flow of data amongst the plurality of tasks used in the developing digital content;
for each of the one or more assets, identifying a corresponding version of the given asset to be used for performing the particular task, wherein a given version of the given asset includes a particular set of versions of a specific set of files associated with the given asset, wherein changes to a version of a given file of the specific set of files, not included within the given version of the given asset, cause no change to the given version of the given asset; and
determining the identified version of each of the one or more assets as the subset of media files.

12. A method of developing digital content, the method comprising:
initiating a request to access media files associated with digital content, the request initiated by a client system when performing a particular task, the request including an indication of the particular task;
in response to the request, receiving a subset of media files from a content manager, the received subset of the media files being used for performing the particular task;
storing the received media files in the client system; and
creating an empty file structure in the client system for an accessed media file not included in the subset of media files received by the client system.

13. The method of claim 12, wherein a portion of the media files, managed by the content manager, is generated by the one or more client systems, wherein a given client system generates a given media file by performing a given task in the given client system, wherein one or more client systems share the media files generated by each other by utilizing the content manager, wherein the given client system is a remote computing system connected to the content manager through a network connection.

14. The method of claim 13, wherein the media files associated with digital content are managed by the content manager, the content manager storing the media files in a database associated with the content manager, the content manager utilizing a version control manager to manage multiple versions of the given media file stored within the database.

15. The method of claim 12, wherein the media files include one or more of:
an asset;
an asset container including one or more components associated with a given asset;
a component associated with the given asset;
a shot, the shot including one or more assets;
a shot container including one or more sub-media files associated with a given shot; and
a sequence of one or more shots.

16. The method of claim 15, wherein a given component included within the given asset includes one or more of:
an art of the given asset;
a model of the given asset;
a rig of the given asset; and
a surface of the given asset.

17. The method of claim 15, wherein the asset includes one or more of:
a character;
a prop used by the character; and
a set within which the animated character and the prop are placed in the given shot.

18. The method of claim 15, wherein a given sub-media file included within the given shot includes one or more of:
a lighting associated with the given shot;
an animation associated with the assets of the given shot;
a previs of the assets included in the given shot; and
a layout of the given shot.

19. The method of claim 12, wherein the plurality of tasks include one or more of:
modeling a given asset included within a given shot;
shading the given asset;
rigging the given asset;
creating previs for the given asset; and
animating the given asset.

20. The method of claim 12, wherein determining the subset of media files includes:
determining a dependency between the particular task and one or more assets to be used for performing the particular task, the dependency determined based on a flow of data amongst the plurality of tasks used in the developing digital content;
for each of the one or more assets, identifying a corresponding version of the given asset to be used for performing the particular task; and
determining the identified version of each of the one or more assets as the subset of media files.

21. A system for developing digital content, the system comprising:
a component configured to receive a request from a client system to access media files associated with digital content, the media files to be used for performing a plurality of tasks, the request including an indication of a particular task to be performed by the client system;
a component configured to determine a subset of the media files to be used for performing the particular task;
a component configured to gather the determined subset of media files; and
a component configured to provide, the client system, access to the gathered subset of media files.

22. The system of claim 21, wherein providing access to the client system includes allowing the media files to be copied to the client system.

23. The system of claim 22, wherein an empty file structure for an accessed media file not being provided to the client system is created in the client system.

24. The system of claim 22, wherein the media files associated with digital content are managed by a content manager, the content manager storing the media files in a database associated with the content manager, the content manager utilizing a version control manager to manage multiple versions of a given media file stored within the database.

25. The system of claim 21, wherein determining the subset of media files includes:
a component configured to determine a dependency between the particular task and one or more assets to be used for performing the particular task, the dependency determined based on a flow of data amongst the plurality of tasks used in the developing digital content;
for each of the one or more assets, a component configured to identify a corresponding version of the given asset to be used for performing the particular task; and
a component configured to determine the identified version of each of the one or more assets as the subset of media files.
